(19) United States
(12) Patent Application Publication
(10) Pub. No.: US 2006/0246874 A1
(43) Pub. Date: Nov. 2, 2006

(54) Cell phone systems

(76) Inventor: Scott L. Sullivan, (US)

Correspondence Address: Scott L. Sullivan, 634 Homer Ave. (#2), Palo Alto, CA, 94301, US

(21) Appl. No.: 11/412,847

(22) Filed: Apr. 27, 2006

Related U.S. Application Data
(60) Provisional application No. 60/676,487, filed on Apr. 28, 2005.

(51) Int. Cl. H04L 12/58

(52) U.S. Cl. 455/412.1

(57) ABSTRACT

A cell phone directory management system includes at least one name and associated telephone number stored in an on-board electronic memory, a timing chip for keeping track of current date and time and a means for date and time stamping the name during a call event (a call event occurs when either the cell phone holder places a call to the named person or when that named person calls the cell phone holder). When a future call event occurs, the present management system indicates or otherwise conveys to the cell phone holder the amount of time that has elapsed between events for that particular named listing in the directory. The means for conveying the time between call events for any particular person listed in the directory can be numerically displayed, audibly conveyed, or graphically displayed. If the time period between call events is longer than a prescribed value, the name in the directory will be either marked to indicate so and/or the cell phone holder can be so notified (such as with a beep and displaying the name), or the name and associated information can be electronically removed from the main directory list in the cell phone and either erased entirely, or simply moved to a different directory so that only the most popular telephone numbers are maintained in the main directory.

### CLAIM OF PRIORITY

Applicant hereby claims priority based on Provisional Patent Application No. 60/676487, filed Apr. 28, 2005 and entitled: “Various Kitchen Products, Automotive, Power Cord-Cover, Cell Phone Systems, Furniture, and a Traffic Light.” The content of the above-listed provisional patent application in its entirety is hereby incorporated by reference.

### BACKGROUND OF THE INVENTION

a) Field of the Invention

This invention is generally directed to cell phones, and more particularly to information management systems for use with cell phones.

b) Description of the Prior Art

Cell phones all include software for managing a plurality of names and associated telephone numbers—the name/number directory. Many phones allow the user to input additional information that is associated to any particular name listed in the directed information, such as birthdays, mailing address, and/or even a photograph. When the cell phone holder places a call from the directory, the user merely selects a name and the phone automatically connects the call. The display on the phone can display the other associated information, including the picture. Similarly, when an incoming call is detected, the cell phone will “link” the incoming telephone number with the called cell phone and try to find a match. If one is found, the information associated with the incoming number is displayed, usually the name of the caller. The caller's picture can also be displayed, as well as a particular sound (at least until the call is answered).

### SUMMARY OF THE INVENTION

A cell phone directory management system includes at least one name and associated telephone number stored in an on-board electronic memory, a timing chip for keeping track of current date and time and a means for date and time stamping the name during a call event (a call event occurs when either the cell phone holder places a call to the named person or when that named person calls the cell phone holder). When a future call event occurs, the present management system indicates or otherwise conveys to the cell phone holder the amount of time that has elapsed between events for that particular named listing in the directory. The means for conveying the time between call events for any particular person listed in the directory can be numerically displayed, audibly conveyed, or graphically displayed. If the time period between call events is longer than a prescribed value, the name in the directory will be either marked to indicate so and/or the cell phone holder can be so notified (such as with a beep and displaying the name), or the name and associated information can be electronically removed from the main directory list in the cell phone and either erased entirely, or simply moved to a different directory so that only the most popular telephone numbers are maintained in the main directory.

### BRIEF DESCRIPTION OF THE DRAWINGS

FIG. 1 is a perspective front view of an opened cell phone, showing details of a tactile output-pad, according to a fourteenth invention; and

FIG. 2 is a perspective rear view of the opened cell phone of FIG. 1, showing details of a tactile input-pad; according to the fourteenth invention.

### DETAILED DESCRIPTION OF THE PREFERRED EMBODIMENTS

Phone-Directory Management

Cell phone users are only too aware of problems associated with keeping an up-to-date phone list (directory). Many people use their cell phones to store phone numbers (and other information) of both long-term relationships, such as “Mom” or sister “Rhondi” and also, short term relationships, such as the number and name of a person at a particular meeting or the number to a movie theater or a pizza place down the street. According to this invention, after a prescribed time period, such short term telephone numbers are automatically erased because all contacts would have a time/date “stamp” associated with them. This stamp is preferably initially set when each telephone number is first stored in the cell phone, and it is reset whenever a call event occurs with that particular telephone number (for example, when the cell phone holder calls a particular number, or when the person of that particular number calls the cell phone holder), or when the cell phone holder resets the “clock” for any particular name/number.

To this end, Applicant suggests automatically deleting (or automatically moving to an electronic memory folder) any particular telephone number in the directory of the cell phone that is not called after a predetermined period of time (as set by the user). For example, if a particular cell phone holder fails to call “Bill” after 3 months (the “set” time to erase a name and number), then the phone will do either or both of two things: 1) flag the name and inform the cell phone holder that “Bill” hasn't been called in 3 months (or any prescribed time period), and 2) move Bill's number and contact information to either the electronic “trash bin” or a separate e-folder within the phone's memory. This way, the phone holder will know who he or she hasn't called in a while, including friends, and also helps keep their directory current and up-to-date.

Additionally, the software stored in the cell phone, according to the present invention, can keep track of the number of times the cell phone holder has called any particular person listed in the cell phone directory, and also the number of times each person listed in the local cell phone directory has called that local cell phone. The software in the phone can use this call number to calculate a call frequency (number of calls over a unit time for each person in the directory). The software according to this invention can convey this information as number of calls, number of minutes or hours of all the calls made to each person, the call frequency, as well as a percentage of call time spent with each listed person or as a percentage of number of calls to each listed person. Furthermore, according to another feature of the present invention, the ratio of the number of calls in from a listed person to the number of calls out to that person can be calculated. Also, the proposed software of this invention can be used to keep track of how much time each party of any particular conversation speaks by detecting the sound signal at the speaker circuit and the microphone circuit of the cell phone holder's cell phone.

All this information can be conveyed to cell phone holder in the form of a displayed number, a displayed graphic (such as a bar-graph or a row of bunny-rabbits, etc.), by color (e.g., green indicates frequent contact, whereas red indicates a long delay since contact), or even sound (through a speaker in the phone or through the headset speaker).

As one of ordinary skill in the art (cell phone user interface software) can appreciate, a simple algorithm and/or program can be used to calculate all of the above-identified values.

Applicant contemplates allowing the cell phone holder to input a “level of importance” for each person listed in the directory. This represents the importance of each listed person. For example, a close relative, girlfriend, or close friend that may not call very often could still remain in the main directory list since this person would have a high level of importance (perhaps using a simple number scale 1-10). The pizza guy, however, may not end up with a very high number and would therefore be bumped from the list fairly soon, unless he is called fairly regularly.

Of course, the present invention for managing the phone directory can include provisions which allow deleted names and contact information to be recovered and returned to the main directory. This recovery action can be automatic if the cell phone holder receives a call from any person on the “deleted” list, or if the cell phone holder calls any person on the deleted list, or as manually initiated by the cell phone holder (without making a call).

Cell Phone Transmits Information to Cell Phone Holder

Cell phones are great, however, their usefulness seems to hinge on the supporting infrastructure, in particular, the cell-sites. Cell sites are repeater transmitters that have been strategically positioned throughout this country according to cell-phone demand, and population, and terrain. Every cell-phone user has experienced, first hand, the problems that occur in managing cellular phone coverage—the dreaded LOW or NO SIGNAL. When a cell phone user enters into a zone of weak or no cell-site coverage, their cell phone signal is reduced either to the point where communication is difficult, or even impossible and the connection is lost.

One annoying problem is that if a signal is reduced or lost, two cell phone users, for example, may be unaware that their phone call has been disconnected (or effectively disconnected by weak signal, or even if the other party just hangs up) and, what often happens, the person who is speaking at the time of disconnect, tends to go on and on (telling in great detail about their trip to Costa Rica) thinking that the other party is still listening. After minutes have past, the talker finally realizes that he is without an audience and must recall the disconnected party and retell the stupid Costa Rica story . . . and nobody wants that (trust me).

To overcome this problem, Applicant offers a cell phone that includes internal circuitry that initiates an audible sound (a beep, or a dial-tone sound) whenever the connected call is disconnected so that he/she will know to stop talking and start redialing. The audible “disconnected” sound preferably emits only through the speaker portion of the headset (i.e., can only be heard by the person using the cell phone). Another audible sound can be generated (again, only through the speaker portion of the headset), when the signal strength attenuates below a predetermined level (to indicate a warning that the call may be lost soon). Additionally, according to another embodiment of this invention, both cell phone users of the called connection will hear an audible sound (generated from one of the two phones) when the signal strength of the connected second cell phone user begins to fade below a predetermined level (i.e., both phone users hear a warning sound so each can make plans to reconnect if necessary).

If the call is disconnected, the audible sound may either be a beep, a dial-tone or can even be a pre-recorded voice announcement (that has been stored in local memory—memory within the cell phone) or music, otherwise, if the signal begins to fade, the warning signal may be any appropriate sound or music.

In a related invention, Applicant contemplates a cell phone that announces other information into the speaker portion of the handset (i.e., to the cell-phone-holder's ear) which may be useful to the cell phone holder. Such information may either be stored locally in onboard electronic memory (e.g., FLASH memory), or (assuming a call remains connected) may be sent to the cell phone from a remote location (such as from the “connected” cell site). The information sent, or announced to the cell phone holder may indicate battery-life remaining (“battery low”), phone connection status (“phone call has been disconnected”), as discussed above, or information regarding the particular person called, which has been previously stored in the cell phone holders cell phone or at a remote site (“Jim's birthday is tomorrow”, where “Jim” is either the called party, or is related to the called party, friend, boss, husband, son, etc.). Other information could convey things like the weather at the called party's location (e.g., “it's raining in NY”, for a 212 area-code number), or just the time either where the caller is, or where the called party is, or to remind the cell phone holder of an upcoming appointment or event that either relates to the called party, or not, such as Easter, or that a particular broadway show is opening in NY (if the area code or GPS location shows a NY location).

Other information could include the number of free minutes remaining in the cell phone payment plan, or the amount of time left to wait before a “free time period”, typical with cell phone plans. When the cell phone holder holds the cell phone to his or her ear (to make a call, or to just to listen to the information—the cell phone can use known sensors to detect if the cell phone is located at the user's ear—such as when the phone is help upright, the flip phone is opened and/or if a light-sensor detects a consistent loss of light, indicated that the phone is against a user's ear), the cell phone itself may “take advantage” of having the cell phone holder's full attention by announcing any relevant information directly into the user's ear.

Whatever the information is, it can be transmitted to the cell phone holder's ear at anytime during the call (in one arrangement, the circuit and controlling software only sends audible information when no one is speaking during the call, as determined by known voice-detecting circuitry “listening” to the conversation), but is preferably sent after the user depresses “send” (or otherwise initiates the call to proceed) and before the cell phone “places” or connects the call. In this manner, the user would have placed the cell phone to his or her ear, and the relevant information could then be heard by the cell phone holder.

The proposed system, according to the invention, preferably waits for the information to be announced to the cell phone holder prior to transmitting the call request information (information used to initiate a call-connection, e.g., handshaking signals to connect with a cell site). This slight delay will allow the cell phone holder to “absorb” and understand the announced information and may even influence his or her decision to make the call. For example, the cell phone holder calls his girlfriend and before the call is “connected”, the cell phone holder's phone announces in his ear that her birthday was yesterday. The cell phone holder can then decide to hold off on calling (smart move) until flowers are sent.

The pertinent information transmitted from the cell phone memory (or from a cell site) could also relate to any incoming calls wherein any information stored in the local memory would be “triggered” by comparing the incoming ID (dell phone number and ID) to the same electronically “attached” to the particular information and further cross-referenced to the date and time, if necessary.

For example, my wife Lana calls me to say “hi”. My phone immediately identifies the incoming call and “links” the ID (Lana) with any pertinent information electronically connected or associated with the identified party and also the current time and date (and also GPS location of both cell phones). By the time I put the phone to my ear, the software of my phone drives the speaker of the handset to announce the information directly to my ear and I hear the information (which in this example is “Anniversary Today!”). This information is preferably audibly conveyed to my ear prior to my cell phone connecting the call with the called party, Lana. Lana could either get a simple pre-recorded message “Scott is being located, please stay on the line”, for example, while I would hear the message. Upon completion of the short information, my cell phone then connects the call and I would immediately say “Hi Lana, did you get my flowers” . . . . [symbol] Alternatively, the circuitry and software of the cell phone holder's cell phone could announce a reminder of the name of the incoming call, for example, “Lana, your wife, is calling”.

The information is preferably a voice recording (pre-recorded or stored by the cell phone holder) or an electronic voice recorded and factory-installed for commonly used events and messages only heard through the speaker portion of the handset (i.e., into the cell phone holder's ear), however, the information may be in the form of a musical tune as well. The cell phone of the present invention includes pre-stored voice messages or recognizable tunes, such as (anniversary, birthday, holidays, or various reminders). Speech generation circuitry and software can also be used to translate typed information (that has been typed into the phone's memory) into an electronic voice that can be outputted through the handset speaker. The user may also record his/her own reminder that will be played back through the handset or through the phone's speaker system according to certain criteria, such as during a particular time, date, or each time, or after a pre-determined number of times, etc. Other information that may be usefully displayed or otherwise conveyed to the phone holder is the last time that person was contacted using the holder's cell phone (either incoming or outgoing).

Auto-Dial in Cell Phone

The signal strength of any particular cell phone is rarely consistently strong during travel. Often is the case when a connected call is lost because one of the parties travels too far from a particular cell tower and the signal becomes too weak to continue the call. The frustrated parties struggle to reconnect their call, often only to lose the connection once again.

One solution to this problem is to ensure that there are sufficient cell sites (or “towers”) so that the signal strength of all connected calls remains strong enough to maintain the connection throughout the world. Unfortunately, however, this solution is unrealistic since many rural areas do not have the necessary cell-phone traffic to justify the relatively expensive cell site coverage so it is likely that signal strength will continue to weaken in many rural and other areas of the United States.

Applicant contemplates not solving the bigger issue of maintaining signal strength, but instead offering a solution to a secondary problem stemming from the main problem. One secondary problem resides in trying to reach a person by cell phone while the caller is driving, for example, and the signal is unreliable. The driver will become easily distracted and continually frustrated as he or she attempts to connect with the particular person, while moving through a poorly populated cell site location.

According to this invention, an auto-dial mode is provided with the cell phone. The auto-dial feature allows the user to first record a message locally on the cell phone (i.e., regardless of signal strength—no signal is transmitted from the phone at this point). Once the message has been stored, the user dials (or selects from a list) the appropriate telephone number and then hangs up, or just puts the phone down.

The phone, in this mode, will continuously (or at set timed intervals) measure cell-site strength and will eventually automatically dial the stored (or selected) number once the signal strength reaches a predetermined and acceptable level.

Once connected, the local cell phone will announce to the called party: “This is a message from Scott Sullivan” (the cell phone holder's name had been previously recorded) and will then play the stored message which could be: “Hey Lana, this is Scott. I got a late start, but I should be at the party before 8 pm tonight”. The system, according to this invention could then provide a chance for the called party to record a response. “if you have something to say to Scott, please record now and he'll contact you as soon as possible” “beep!”

Once the recorded message is sent, the local cell phone would confirm this fact to the cell phone holder (“Scott”, who is driving, in this example, apparently through Kansas) by audible or visual indication (light and/or sound) and would also indicate if the called party left a message in response. The message would, in this case, be stored locally on the cell phone so that the caller (the one who is still driving through Kansas) can retrieve the message locally, without requiring any cell signal strength at all.

Messaging Management Invention

When a caller calls a particular cell phone and leaves a message, the message is electronically stored at a central server location. The called party can later retrieve the message by calling the central server and accessing his or her account. However, if the caller is using his or her cell phone and is in an area that does not have sufficient signal strength (e.g., rural areas) then no calls can be made and no messages heard. According to the present invention, the called cell phone automatically dials-in to the central server at prescribed times whenever sufficient signal strength exists, as monitored, or during otherwise known downtimes throughout the day, or when there is indication of a message waiting. Once the cell phone connects with the central server, the messages will be downloaded (or the first 10 or 20 seconds of each of several messages if local memory space is limited) to onboard electronic memory located on the cell phone.

In this manner, the called party can listen to stored messages even at times when signal strength is low at the location of the cell phone since the messages would have been transferred to local memory on the cell phone, itself. According to another embodiment of the invention, only messages from select callers would be transferred or forwarded to local memory, as predefined by the cell phone holder (during set up), e.g., only calls from Mom, Lana and Morgan get through.

Cell Phone Message Management

When a cell phone receives phone calls and the cell phone is not answered, those calls are typically either forwarded to another telephone, or directed to a message-recording service. The cell phone holder may then later call the service and retrieve the messages. According to this invention, a cell phone may be in vibrate or silent mode for all incoming calls, but may be preset to change to normal ringing, for example, should a pre-selected caller connect. For example, Scott is at work and doesn't want his phone to ring, unless it is his lovely wife, Lana, at which point he wants the phone to ring, regardless of the annoying looks his coworkers will invariably give him. So this invention allows a user to select the ring-tone and/or silent/vibrate according to the person calling.

According to another embodiment of the invention, the ring-tone and/or silent/vibrate mode can be set according to a voice-message indication alarm. For example, the invention here allows for a cell phone to maintain a silent or vibrate ring condition for ALL incoming calls, however, if a message is left by a particular caller, the cell phone will then provide a caller-specific indication that a particular caller has left a message. In the above example, if Lana leaves a voice message for Scott, then Scott's phone will emit a particular pre-selected tone (such as a quiet single beep) even though Scott's cell phone is otherwise set on silent or vibrate mode)—all other messages sent to Scott's cell phone would be announced according to the original silent or vibrate mode, in this example. This invention allows for a cell phone holder to know immediately when select people (as determined by name, area code, GPS location, and/or prefix (middle three numbers of a telephone number), or even at an exact time fo day (calls can be received only between Noon and 12:10 PM) leave a voice message on his phone.

Tactile Cell Phone

A great man once said: “communication is everything” and the more senses you use to communicate with, the better. Cell phones have allowed more and more people to reach each other and more frequently over impossible distances at the touch of a few buttons. But through all this easy-access communication, we seem to be missing out on something very human—touch!

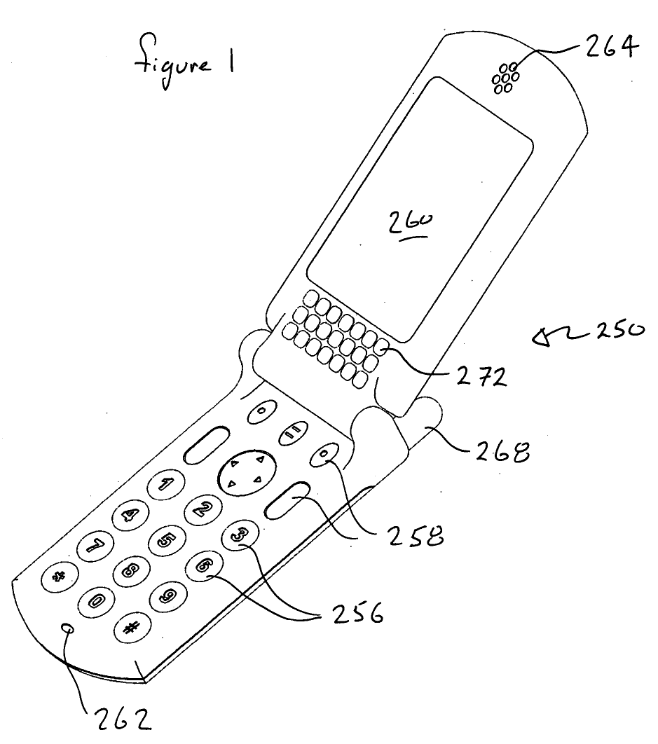

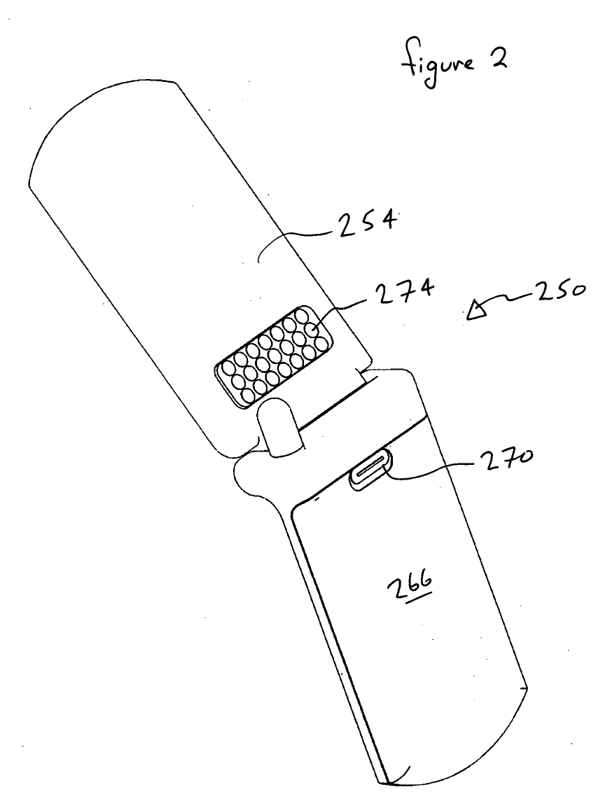

According to the present invention and referring to FIGS. 1 and 2, a cell phone 250 is shown having an inside surface 252 (this is the surface that contacts a user's face when the cell phone is being used) and an outside surface 254 (this is the surface that contacts a user's hand when using the phone). Cell phone 250 further includes conventional components, including a keypad 256, control buttons 258, a display 260, a microphone pickup 262, a speaker 264, a battery cover 266, an antenna 268, and a battery-release 270. According to the invention, cell phone 250 further includes a tactile-output pad 272, and a tactile-input pad 274. Tactile-output pad 272 is preferably located on inside surface 252 of cell phone 250 so that tactile-output pad 272 contacts the user's face (preferably his or her cheek), when he or she uses the cell phone 250 in a normal, against-the-face manner. Tactile-input pad 274 is preferably located in a comfortably-accessible location anywhere on the cell phone 250, such as on the outside surface 254, as shown in FIG. 2.

In normal use of the cell phone 250, tactile-input pad 274 may be easily touched (and thereby operated) by any of the cell-phone-holder's fingers, as described below. The purpose of tactile input pad 274 is to convert any contact of the pad 274 (from a user's finger, for example) into electrical-signals that convey the relative location of the area being touched on the pad. For example, if a user touches the upper right section of the tactile-input pad 274, then the pad (and any supporting circuitry) will generate electrical signals that convey information that the upper right section of the pad 274 has been touched. In a preferred embodiment, the contact force that the user applies to the surface of the tactile-input pad 274 is also measured and conveyed in the generated electrical signals.

Tactile-input pad 274 can be similar to the touch-surface used with the popular iPod music-storage player made by Apple, Inc. of Cupertino, Calif., or the touch pad cursor-controller used with many different laptop computers, such as the popular IBM Think Pad. In such case, the user controls the location of the computer's cursor on the screen by simply touching the touch pad with his or her finger. Such touch-screen technology is well known by those skilled in the art and many different types can be used with the present invention, including capacitive-type switches that are isolated into an array or even an array of membrane-type switches. Tactile-input pad 274 is shown in FIG. 2 as separate elements (or “digits”) of an array, however, this is just to illustrate the operation of the invention and it should be understood that any appropriate input device can be used here to convey location and possibly pressure information from a touched panel. Also, although a flip-type cell phone is shown in the figures, any type of cell phone (or even a pager-type device) can be used to carryout the present invention, including a signal transmitting device that is dedicated to transmitting only touch-signals to another device designed to receive such signals and translate to selective mechanical displacement, according to the invention.

Tactile-output pad 272 is a transducer array that translates an electrical signal into coordinate mechanical displacement. The mechanical displacement may be generated by relatively slow linear movement devices (similar to so-called electronic transducer Braille tactile plates) or higher-frequency vibration movement. As an example, tactile-output pad 272 may be made from an array of piezo crystals, positioned in an array of perhaps 4 by 8 crystals or “digits”. The crystals in this example are wired so that each of the 32 crystals can be independently activated with an appropriate electric signal. Each activated crystal in the array will vibrate in such a manner that collectively the array can mimic the feel of a finger moving gently across the surface of someone's skin.

Each “digit” of the tactile-output pad 272 may be made from a micro electromagnetic transducer (like a very very small solenoid). Each solenoid, in this example turns on and off and creates linear displacement, which collectively mimics the feel of someone touching a person's skin with their finger.

The cell phone 250, according to the invention works in pairs (like walkie talkies). When a first cell phone user calls another one (wherein both users have this system) and the “touch mode” is turned on, either user may selectively touch their respective local tactile-input pad 274 and generate a stream of electrical signals that convey the touch pattern (movement, direction, range, area of coverage, and intensity or pressure of the touch) each person makes on their respective pad 274 of their respective phone 250.

The signals generated by the first user are processed and transmitted to the cell phone of the second user as a data signal. Once received by the second user's cell phone 250, the received “touch” signal is extracted, processed, and used to drive the tactile-output pad 272 of the second user's cell phone. The “touch” signals generated by the second user are similarly transmitted to the cell phone of the first user, received, extracted, processed and use to drive the tactile-output pad 272 of the first user's cell phone 250. The intensity and duration of each activated “digit” of each respective tactile-output pad 272 may be varied, as desired by each user. Any of a variety of software controlling programs may be used to drive the tactile-output pad 272, as can easily be understood by any of the thousands of programmers working late in California right now. In one example, the software program would translate a higher pressure of finger contact at one phone into either a more-intense vibration at the second cell phone, or a perhaps a higher vibration, or a longer period of vibration for each activated “digit”.

The tactile-output pad 272 may be formed integrally with the keypad 256 wherein each numbered key button, for example, functions as one “digit” of the array making up the tactile-output pad 272, creating a larger contact surface and using the cell-phone surface real-estate more efficiently. The tactile-input pad 274, may be located on the battery-cover 266 and may therefore provide a larger touch pad.

Also, sound and/or lights may be simultaneously activated at the sending cell phone, the receiving cell phone, or both in response to either user touching their respective input pad 274.

Since not everyone wants to touch (either literally, or digitally) the face of everyone they call, the “touch mode” of the cell phone 250 may be activated or deactivated as desired and may turn on automatically when selected people call (likely, just the girlfriend, or wife, for example, but not your travel agent, Bob).

The power requirements for the various components of this digi-touch system, described above, are preferably met using power from the onboard cell phone battery. The number of “digits” used in the array of the tactile-output pad 272 may vary, depending on cost factors, size requirements, and power usage availability. Generally, the higher the resolution, the better the feel, but several factors will affect this illusion of touch including, vibration frequency, areas of each “digit” in the array, magnitude of displacement (or amplitude) of each “digit”, when activated, and so on.

The end result of this digi-touch system is the ability for people who are located out of reach and are restricted to voice-only communication to now reach” each other using the sensual sense of touch, even if it is known to all parties that the “touch” they feel is not direct, but an electronic illusion of the same, brought to you by AT&T, for example..

Unfortunately, I'm certain the various telephone companies in this country will find a variety of ways to charge for and promote this “touch” feature. Perhaps as many ways as the government will find to tax it.

According to another related invention, the tactile-input pad 274 located on the outer surface of cell phone 250 is used as a cursor controller for cell phones or even PDA's whereby a user may control aspects of the display (move the cursor, or make selections) using a touch-control pad (the tactile-input pad) located on the REAR surface of the cell phone or PDA (e.g., on the battery cover 266, for example). This touch-control pad preferably is only operational when the cell phone or PDA is held generally horizontally and deactivated when the cell phone is held to the face.

In a related embodiment of this invention, either the tactile-input pad 274, the tactile-output pad 272 or both may be separate electronic devices that are designed to connect with a cell phone (and may include their own power supply), but otherwise operate in a similar manner to the above-described embodiment. In such instance, either separate electronic device (pads 272, 274) may be designed to be worn by the cell phone holder, anywhere on his or her body. In particular, each user may wear a face mask (each of which incorporating both input and output transducers) which selectively generates touch signals and commands which control each other's mask over the cell phone connection.

What is claimed is:

1. A system for conveying information within in a cell phone of the type including a speaker, controlling circuitry, and electronic memory, said system comprising:
at least one listing of information located in said electronic memory, said listing including a telephone number;
a second information stored in said electronic memory, said second information relating to said first information; and
means for transforming said second information from said electronic memory into an audible signal and transmitting said audible signal through said speaker of said cell phone, in response to a call-event that is associated with said first information.
